(19) United States
(12) Patent Application Publication
(10) Pub. No.: US 2008/0127464 A1
(43) Pub. Date: Jun. 5, 2008

(54) Buckle devise

(75) Inventor: Ted Ju, Keelung City (TW)

Correspondence Address: TROXELL LAW OFFICE PLLC, SUITE 1404, 5205 LEESBURG PIKE, FALLS CHURCH, VA, 22041, US

(73) Assignee: Lotes co., Ltd.

(21) Appl. No.: 11/607,047

(22) Filed: Dec. 1, 2006

(51) Int. Cl. G06F 1/16

(52) U.S. Cl. 24/593.1

(57) ABSTRACT

A buckle devise has a sheath and bolt capable of being inserted into the sheath. The sheath includes a main body and a buckling portion extending from the main body. The buckling portion has an incline for buckling a reversing devise. A buckle devise of another embodiment has a sheath and a bolt capable of being inserted into the sheath. The sheath has a main body and a buckling portion extending from the main body. The buckling portion has a protrusion to provide the sheath for resisting thereof. Comparing to the prior art, the buckle devise can buckle a reserving devise firmly so that the reserving devise have not a shaking phenomenon unstably.

### BACKGROUND OF THE INVENTION

(a) Field of the Invention

The present invention relates to buckle devises, and in particular a buckle devise serving to fix a heat dissipating device to a CPU.

(b) Description of the Prior Art

An operating process of a CPU often produces lots of heat. If the heat is not dissipated in time, the heat without being dissipated can impede a normal operation of the CPU. Therefore the heat dissipating device is not only a required devise but also a important equipment. A buckle devise is installed in the computer so as to retain the heat dissipating device. The buckle devise of a prior art includes generally a sheath and a bolt capable of being inserted into the sheath. The sheath has a main body and a buckling portion extending from the main body. The middle of the sheath has a vertical slot passing through the upper end to the down end thereof. The buckling portion is separated by the vertical slot into the right and the left part. The end of the buckling portion has a hook. When the sheath passes through an electric board, the hook can buckle with the electric board so that the heat dissipating device is connected to the electric board. However, the buckle devise for connecting the electric board is easy to become loose, because the buckle devise is connected with the electric board only by a surface of the hook. The buckle devise is easy to be shaken when assembling. The buckle devise can not be buckled to the electric board effectively so as to impede the heat dissipation function of the heat dissipating device.

Therefore, it is necessary to have a novel buckle devise to overcome the defects of the prior art.

### SUMMARY OF THE INVENTION

The primary objective of the present invention is to provide a buckle devise capable of buckling a reserving devise firmly. The buckle devise has a sheath and a bolt capable of being inserted into the sheath. The sheath has a main body and a buckling portion extending from the main body. The buckling portion has an incline capable of buckling a reserving devise.

The second objective of the present invention is to provide a buckle devise. The buckle devise has a protrusion capable of providing the sheath for resisting thereof in the embodiment.

Comparing to the prior art, the buckle devise can buckle a reserving devise firmly so that the reserving devise have not a shaking phenomenon unstably.

### BRIEF DESCRIPTION OF THE DRAWINGS

FIG. 1 is an assembled perspective view of the buckle devise of the present invention.

FIG. 2 is an exploded perspective view of the buckle devise of FIG. 1.

FIG. 3 is an exploded perspective view of the other angle of FIG. 1.

FIG. 4 is a cross-sectional view of the buckle devise of the present invention.

FIG. 5 is a cross-sectional view of the second embodiment of the buckle devise of the present invention.

FIG. 6 is a cross-sectional view of the third embodiment of the buckle devise of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

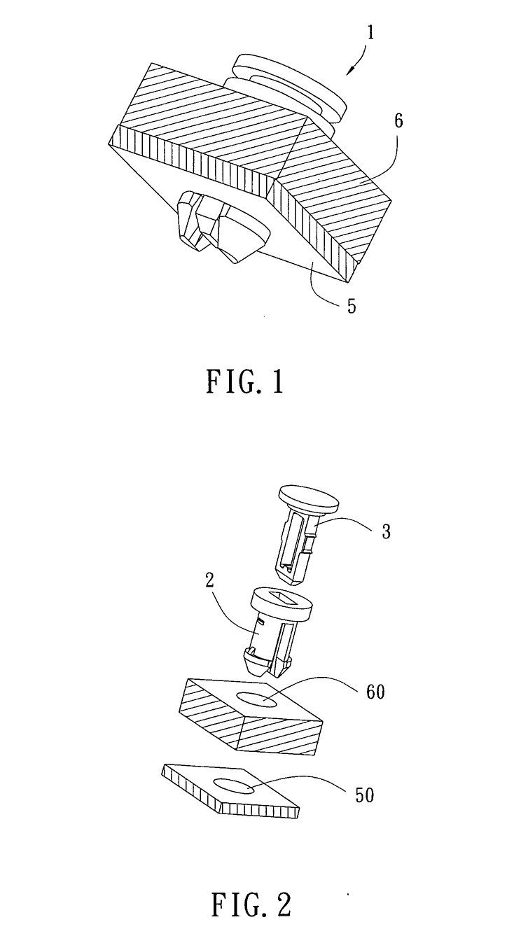

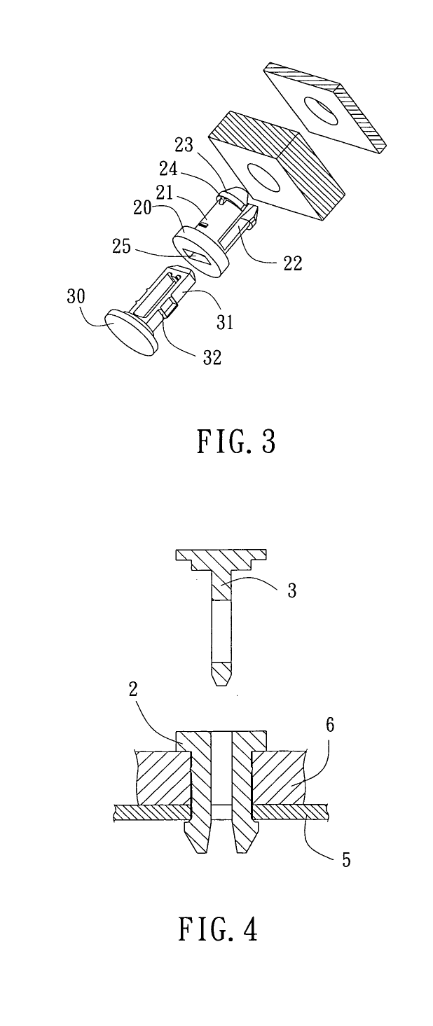

Referring to FIG. 1 to 6, the buckle devise of present invention can be fixed on a fixing unit (An electric board 5 is illustrated partially with FIG. 1 in this embodiment,) so as to buckle a second unit (A prop 6 is illustrated partially with FIG. 1 in this embodiment. The second unit can be another connecting unit, such as an electric board). The electric board 5 and the prop 6 are respectively corresponding to a connecting hole 50 and 60 so that the buckle devise 1 can pass through the connecting hole 50 and 60 for fixing. The buckle devise 1 has a sheath 2 and a bolt 3 capable of being inserted into the sheath 2. The sheath 2 has a main body 20 and a buckling portion 21 extending from the main body 20. The buckling portion 21 has an incline for buckling an electric board. The middle of the sheath 2 has a vertical slot 22 passing through from the upper end to the bottom end. The buckling portion 21 is separated to be the right and the left parts by the vertical slot 22. The end of the buckling portion 21 has a hook 23. The buckling incline is installed on the hook 23. In this embodiment, the incline is a wedge-shape piece 24 (A circular protrusion can be installed surely on the buckling portion 21 and the incline can be an inverse angle of the circular protrusion). Besides, the main body 20 has a square-shape through hole 25 capable of interlinking the vertical slot 22. The bolt 3 can be inserted into the square-shape through hole 25. The bolt 3 has a main body 30 and an inserting portion 31 extending from the main body 30. The two sides of the upper end of the inserting portion 31 have buckles 32 so as to buckle with the upper portion of the vertical slot 22.

When assembling, the prop 6 is aimed at the connecting hole 50 and 60 of the electric board 5 at first. Then the sheath 2 is inserted downwards into the connecting hole 50 and 60. During the process of inserting the sheath 2, the left and right of the sheath 2 are drawn in. When the sheath 2 is positioned on proper location, the two hooks 23 of the sheath 2 are propped up and hooked on the bottom of the electric board 5 because of elasticity effect. The incline can be resisted against the edge of the connecting hole 60. The electric board 5 receives both the horizontal and vertical forces. The bottom of the main body 20 of the sheath 2 is resisted against the surface of the prop 6. Then, the bolt 3 is aimed at the square-shape through hole 25 of the sheath 2 and is inserted downward into thereof. After the bolt 3 is inserted totally, the buckles 32 on the two sides of the bolt 3 can be buckled with the upper portion of the vertical slot 22 so as to finish the assembling process. The buckle devise is convenient for using and the connection of the buckle devise is reliable very mush.

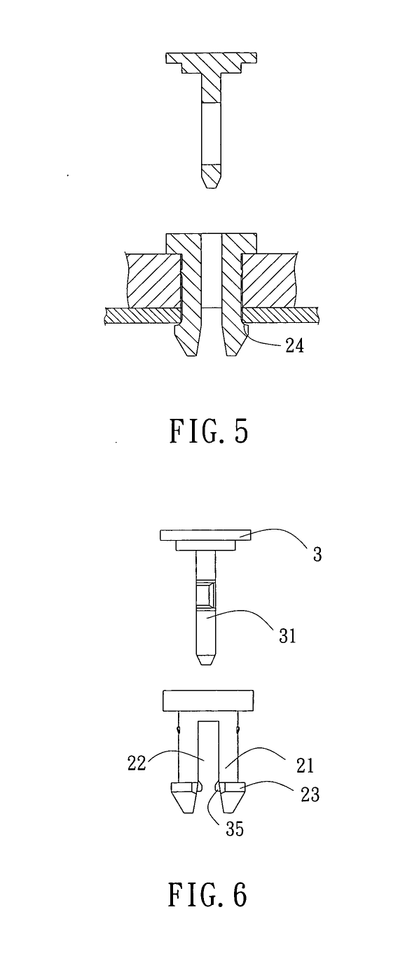

Referring to FIG. 5, the second embodiment of the buckle devise of the present invention is different from the first embodiment. The incline of the second embodiment is an arc-shape piece 24 (The circular protrusion can also be installed on the buckling portion and the incline can be a round angle of the protrusion). The second embodiment can have the same function as the first embodiment.

Referring to FIG. 6, the third embodiment of the buckle devise of the present invention is different from the first embodiment. The buckling portion 21 has no any incline, but the protrusion 35 is installed on the buckling portion 21 so as to provide the sheath 2 for resisting. The protrusion 35 is positioned on the vertical slot 22. Besides, the buckling portion 21 on both the left and the right has respectively each protrusion 35. When assembling, the inserting portion 31 is inserted downward into the passing hole. The protrusion 35 can open the hook 23 outward so as to resist against the electric board. The third embodiment can have the same function as the first embodiment.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A buckle devise comprising:
a sheath; the sheath having a main body and a buckling portion extending from the main body; and the buckling portion having a incline for buckling a reserving devise; and
a bolt capable of being inserted into the sheath.

2. The buckle devise as claimed in claim 1, wherein the buckling portion has a circular protrusion; and the incline is a reverse projection on the protrusion.

3. The buckle devise as claimed in claim 1, wherein the buckling portion has a circular protrusion; and the incline is a round projection on the protrusion.

4. The buckle devise as claimed in claim 1, wherein the incline is a wedge-shape piece.

5. The buckle devise as claimed in claim 1, wherein the incline is an arc-shape piece.

6. The buckle devise as claimed in claim 1, wherein the middle of the sheath has a vertical slot passing through the upper end to the bottom end thereof; the buckling portion is separated by the vertical slot to be the right and the left part; the end of the buckling portion has a hook; and the incline is positioned on the hook.

7. A buckle devise comprising:
a sheath; the bolt having a main body and a buckling portion extending from the main body; and the buckling portion having a protrusion to provide the sheath for resisting thereof; and
a bolt capable of being inserted into the sheath.

8. The buckle devise as claimed in claim 7, wherein the middle of the sheath has a vertical slot passing through the upper end to the bottom end thereof; the buckling portion is separated by the vertical slot to be the right and the left part; and the protrusion is positioned in the vertical slot.

9. The buckle devise as claimed in claim 7, wherein the buckle devise on the right and the left has respectively each a protrusion.

10. The buckle devise as claimed in claim 7, wherein the bolt has a main body and a inserting portion extending from the main body capable of resisting against the protrusion.
